(19) United States
(12) Patent Application Publication
(10) Pub. No.: US 2011/0115365 A1
(43) Pub. Date: May 19, 2011

(54) Display device and method of manufacturing display device

(76) Inventor: Won-Kyu Kwak, Yongin-City (KR)

(21) Appl. No.: 12/926,379

(22) Filed: Nov. 15, 2010

(30) Foreign Application Priority Data
Nov. 16, 2009 (KR) 10-2009-0110478

(51) Int. Cl. H01J 5/00; H01J 9/26

(52) U.S. Cl. 313/317; 445/25

(57) ABSTRACT

A display device and a method of manufacturing the display device, the device including a first substrate; a display unit on the first substrate, the display unit being for displaying an image; a wire unit between the display unit and the first substrate, the wire unit being for transferring a signal to the display unit; a second substrate opposite to the first substrate with the display unit interposed therebetween; a sealant between the first substrate and the second substrate; and a light adjustment pattern on the second substrate, the light adjustment pattern overlying the sealant to adjust an amount of light transmitted therethrough.

### BACKGROUND

1. Field

Embodiments relate to a display device and a method of manufacturing the display device.

2. Description of the Related Art

A display device is a device that displays an image, and currently an OLED display is in the spotlight.

The OLED display has self luminous characteristics, i.e., does not require a separate light source. Thus, unlike a liquid crystal display (LCD) device, the OLED display may have reduced thickness and weight. Further, the OLED display may have high quality characteristics, e.g., low power consumption, high luminance, and a high reaction speed.

An OLED display may include a display substrate having an OLED thereon, an encapsulation substrate disposed opposite to the display substrate to protect the OLED of the display substrate, and a sealant, e.g., epoxy or frit, that adheres and seals the display substrate and the encapsulation substrate.

In order to adhere and seal the display substrate and the encapsulation substrate, after interposing the sealant between the display substrate and the encapsulation substrate, the sealant may be cured.

The above information disclosed in this Background section is only for enhancement of understanding of the background of the described technology and therefore it may contain information that does not form the prior art that is already known in this country to a person of ordinary skill in the art.

### SUMMARY

Embodiments are directed to a display device and a method of manufacturing the display device which represent advances over the related art.

It is a feature of an embodiment to provide a display device and a method of manufacturing the same having a uniformly cured sealant

At least one of the above and other features and advantages may be realized by providing a display device including a first substrate; a display unit on the first substrate, the display unit being for displaying an image; a wire unit between the display unit and the first substrate, the wire unit being for transferring a signal to the display unit; a second substrate opposite to the first substrate with the display unit interposed therebetween; a sealant between the first substrate and the second substrate; and a light adjustment pattern on the second substrate, the light adjustment pattern overlying the sealant to adjust an amount of light transmitted therethrough.

The sealant may extend along a surface of the first substrate to enclose the display unit, and the light adjustment pattern may be disposed on the second substrate to overlie the sealant.

The light adjustment pattern may have a pattern density, the pattern density increasing toward a central area corresponding to a central portion of the sealant.

The sealant may include a corner portion, the light adjustment pattern may include a portion overlying the corner portion of the sealant and having a pattern density, and in such portion of the light adjustment pattern which overlies the corner portion of the sealant, the pattern density may increase toward an inside area corresponding to an inside portion of the sealant adjacent to the display unit.

A portion of the wire unit may be disposed between the sealant and the first substrate, the light adjustment pattern may include a portion overlying the portion of the wire unit between the sealant and the first substrate, and the light adjustment pattern having a pattern density, and the pattern density of the light adjustment pattern portion overlying the wire unit may be greater than a pattern density of portions of the light adjustment pattern not overlying the wire unit.

The wire unit may include at least one thin film transistor, the thin film transistor having a gate electrode, a source electrode, a drain electrode, and an active layer.

The display unit may include a first electrode electrically connected to the drain electrode; an organic emission layer on the first electrode; and a second electrode on the organic light emitting layer.

The display device may further include a light interception unit on the second substrate, the light interception unit surrounding the light adjustment pattern and defining a width of the light adjustment pattern.

The sealant may be frit, the frit being curable by laser light.

The display device may further include a first substrate wire on a second surface of the second substrate and opposite to a first surface of the second substrate, the first surface of the second substrate facing the display unit, and the light adjustment pattern may be disposed on the second surface in a same plane as the first substrate wire.

The display device may further include a second substrate wire on a first surface of the second substrate, the first surface facing the display unit, and the light adjustment pattern may be disposed on the first surface in a same plane as the second substrate wire.

At least one of the above and other features and advantages may also be realized by providing a method of manufacturing a display device, the method including forming a wire unit and a display unit on a first substrate such that the display unit receives a signal from the wire unit; forming a light adjustment pattern on a second substrate such that the light adjustment pattern adjusts an amount of light transmitted therethrough; adhering together the first substrate and the second substrate with the display unit interposed therebetween by interposing a sealant between the first substrate and the second substrate such that the sealant encloses at least a part of the display unit and such that the light adjustment pattern overlies the sealant; and curing the sealant by irradiating laser light to the sealant through the light adjustment pattern.

Irradiating laser light to the sealant through the light adjustment pattern may change an intensity of the laser light from a Gaussian profile form to a flat profile form having a first heat energy.

Irradiating laser light to a corner portion of the sealant through the light adjustment pattern may change an intensity of the laser light from a Gaussian profile form to a stepped flat profile form having a first heat energy and a second heat energy lower than the first heat energy.

Irradiating laser light to a portion of the sealant overlying a portion of the wire unit through the light adjustment pattern may change an intensity of the laser light from a Gaussian profile form to a flat profile form having a third heat energy less than the first heat energy.

The method may further include forming a first substrate wire on a second surface of the second substrate opposite to a first surface of the second substrate facing the display unit, and the light adjustment pattern may be formed simultaneously with and in a same plane as the first substrate wire.

The method may further include forming a second substrate wire on a first surface of the second substrate to face the display unit, and the light adjustment pattern may be formed simultaneously with and in a same plane as the second substrate wire.

The method may further include forming a light interception unit at sides of the light adjustment pattern such that the light interception unit defines a width of the light interception pattern.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 illustrates a top plan view of a display device according to an embodiment;

FIG. 2 illustrates a cross-sectional view of the display device taken along line

II-II of FIG. 1;

FIG. 3 illustrates an enlarged view of a portion A of FIG. 1;

FIG. 4 illustrates an enlarged view of a portion B of FIG. 1;

FIG. 5 illustrates an enlarged view of a portion C of FIG. 1;

FIG. 6 illustrates a layout view of a structure of a pixel of the display device of FIG. 1;

FIG. 7 illustrates a cross-sectional view of the pixel taken along line VII-VII of FIG. 6;

FIG. 8 illustrates a flowchart of a method of manufacturing a display device according to an embodiment;

FIGS. 9 to 11 illustrate stages in the method of manufacturing a display device of FIG. 8;

FIG. 12 illustrates graphs of heat energy profiles of laser light used to cure sealant in the method of manufacturing a display device of FIG. 8; and

FIG. 13 illustrates a cross-sectional view of a display device according to another embodiment.

### DETAILED DESCRIPTION

Korean Patent Application No. 10-2009-0110478, filed on Nov. 16, 2009, in the Korean Intellectual Property Office, and entitled: “Display Device and Method of Manufacturing Display Device,” is incorporated by reference herein in its entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the drawing figures, the dimensions of layers and regions may be exaggerated for clarity of illustration. It will also be understood that when a layer or element is referred to as being “on” another layer or substrate, it can be directly on the other layer or substrate, or intervening layers may also be present. In addition, it will also be understood that when a layer is referred to as being “between” two layers, it can be the only layer between the two layers, or one or more intervening layers may also be present. Like reference numerals refer to like elements throughout.

Further, like reference numerals designate like elements in several exemplary embodiments and are representatively described in the first exemplary embodiment, and different elements from those of the first exemplary embodiment will be described in other exemplary embodiments.

Further, in the following description, in an embodiment, an OLED display including an organic emission layer is described as a display device. However, the display device is not limited thereto; and the display device according to an embodiment may be another type of display device, e.g., a LCD, a plasma display panel (PDP), and a field emission display.

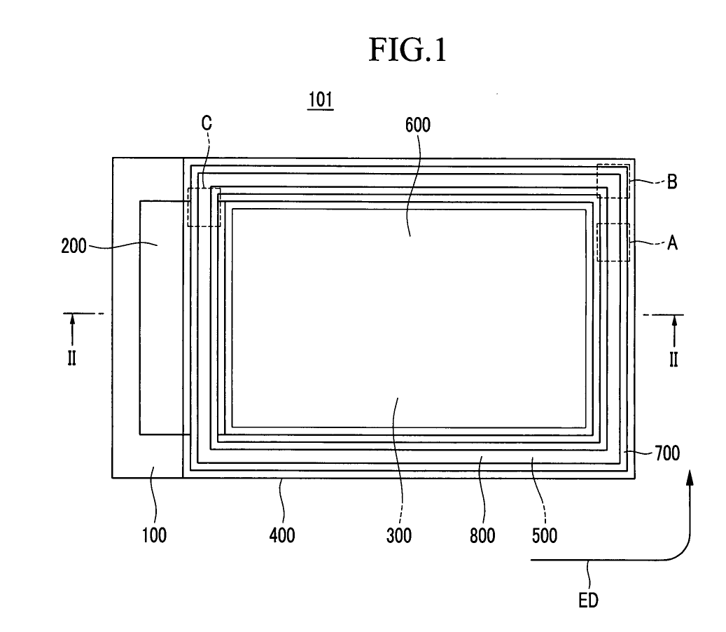

A display device 101 according to an embodiment will be described hereinafter with reference to FIGS. 1 to 7.

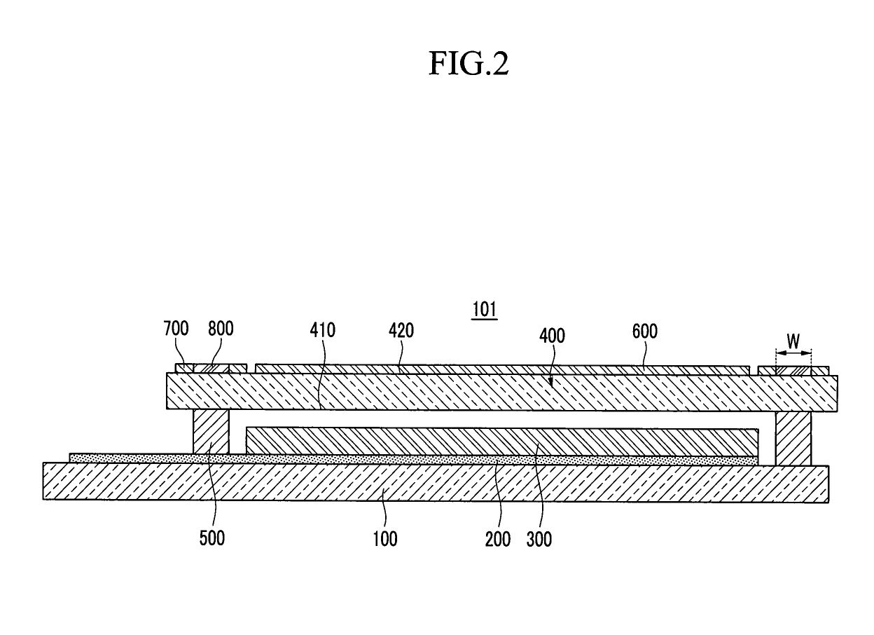

FIG. 1 illustrates a top plan view illustrating a display device according to an embodiment. FIG. 2 is a cross-sectional view of the display device taken along line II-II of FIG. 1.

As illustrated in FIGS. 1 and 2, the display device 101 according to the present embodiment may include a first substrate 100, a wire unit 200, a display unit 300, a second substrate 400, a sealant 500, a first substrate wire 600, a light interception unit 700, and a light adjustment pattern 800.

The first substrate 100 may be an insulation substrate made of, e.g., glass, a polymer, or a metal. The wire unit 200 may be disposed on the first substrate 100.

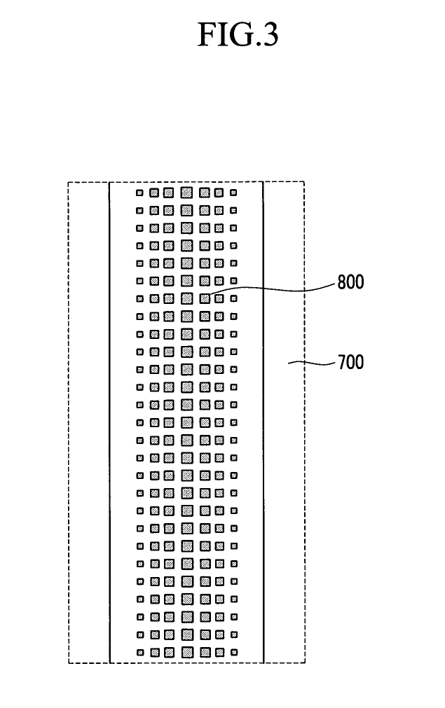

The wire unit 200 may include first and second thin film transistors 10 and 20 (shown in FIG. 3). The wire unit 200 may drive the display unit 300 by transferring a signal to the display unit 300. The display unit 300 may emit light according to the signal received from the wire unit 200. The display unit 300 may be disposed on the wire unit 200.

The display unit 300 may be positioned at a display area on the first substrate 100. The display unit 300 may be formed using microelectromechanical systems (MEMS) technology, e.g., photolithography. The display unit 300 may display an image and may include, e.g., an OLED. However, the display unit 300 is not limited thereto, and in an alternative implementation the display unit 300 may include, e.g., a liquid crystal display, plasma display, and discharge pin display, according to a configuration of the display device 101. That is, the display device 101 may be, e.g., an LCD, a PDP, or a field emission display (FED). The second substrate 400 may be disposed on the display unit 300.

The second substrate 400 may be a light transmitting insulation substrate including, e.g., glass, a polymer, or a metal. The second substrate 400 may be opposite to the first substrate 100 with the wire unit 200 and the display unit 300 interposed therebetween. The second substrate 400 may be adhered to the first substrate 100 with the sealant 500 to thereby seal the display unit 300 together with the first substrate 100 and the sealant 500.

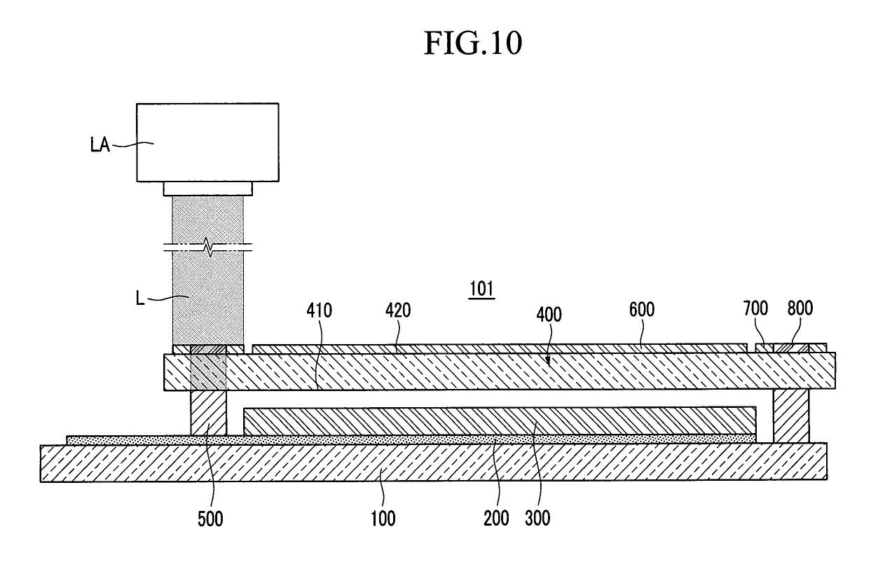

The sealant 500 may be disposed between the first substrate 100 and the second substrate 400 and may enclose the display unit 300 therein. In particular, the sealant 500 may extend along a surface of the first substrate 100 to enclose the display unit 300 therein. The sealant 500 may include, e.g., frit, and may be cured by laser light L (shown in FIG. 10) to seal the display unit 300 between the first substrate 100 and the second substrate 400. The sealant 500 may be entirely uniformly cured, i.e., may be uniformly cured along an entire width W thereof. The curing may be performed by irradiating laser light L through the light adjustment pattern 800. Curing with the laser light L through the light adjustment pattern 800 will be described below.

The first substrate wire 600 may be positioned on the second substrate 400 to correspond to, i.e., to overlie, the display unit 300. The first substrate wire 600 may be formed on a second surface 420 of the second substrate 400 opposite to a first surface 410 of the second substrate 400 facing the display unit 300. The first substrate wire 600 may include at least one of, e.g., a metal wire, at least one thin film transistor, and a sensing material. The first substrate wire 600 may facilitate a touch screen function. The light interception unit 700 and the light adjustment pattern 800 may be formed on the second surface 420 of the second substrate 400 in the same plane as the first substrate wire 600. The light adjustment pattern 800 may correspond to, i.e., may overlie, the sealant 500 between the first substrate 100 and the second substrate 400.

The light interception unit 700 may be positioned with the light adjustment pattern 800 disposed therein. In other words, the light interception unit 700 may surround sides of the light adjustment pattern 800. A width W of the light adjustment pattern 800 may be defined by a space within the light interception unit 700. The light interception unit 700 may define a width of laser light L radiated to the sealant 500 through the light adjustment pattern 800 by intercepting a part of laser light L (shown in FIG. 10) outside of the light adjustment pattern 800. The light interception unit 700 may be formed by a same process used to form the first substrate wire 600. In particular, when the first substrate wire 600 includes a metal wire, the light interception unit 700 may be formed at the same time using a same mask as a metal wire of the first substrate wire 600.

The light adjustment pattern 800 may be positioned on the second substrate 400 to correspond to, i.e., overlie, the sealant 500. The light adjustment pattern 800 may, e.g., adjust an amount of light transmitted through the light adjustment pattern 800. In particular, the light adjustment pattern may have a pattern density that adjusts an amount, i.e., intensity, of laser light transmitted therethrough. In other words, an area of the light adjustment pattern 800 having a greater pattern density lowers an intensity of the laser light passing therethrough and vice versa. The light adjustment pattern 800 may be formed on the second substrate 400 in an elongation direction ED of the sealant 500, which may extend on a surface of the first substrate 100 between the first substrate 100 and the second substrate 400. The light adjustment pattern 800 may be positioned between neighboring light interception units 700 and may include a plurality of patterns. When forming the first substrate wire 600, the light adjustment pattern 800 may be formed by the same process. In particular, when the first substrate wire 600 includes a metal wire, the light adjustment pattern 800 may be formed a same mask used to form the metal wire of the first substrate wire 600.

The plurality of patterns of the light adjustment pattern 800 may change according to a forming position and an extension form, i.e., position and shape, of the sealant 500, as will be described hereinafter in detail.

The sealant 500 of a portion A of FIG. 1 may extend along a direction on a surface of the first substrate 100 between the first substrate 100 and the second substrate 400. Further, the sealant 500 of the portion A of FIG. 1 may directly contact the first substrate 100.

FIG. 3 illustrates an enlarged view of the portion A of FIG. 1.

As illustrated in FIG. 3, in the light adjustment pattern 800 corresponding to portion A of FIG. 1, in order to transform heat energy, i.e., intensity, of laser light L (shown in FIG. 10) transmitted through the light adjustment pattern 800 from a Gaussian profile form to a flat profile form, the pattern density may increase toward a central area of the light adjustment pattern 800 corresponding to a central portion of the sealant 500. Thus, in the light adjustment pattern 800 of FIG. 1 overlying the sealant 500, the pattern density may increase toward a central area corresponding to a central portion of the sealant 500. Accordingly, due to the increased pattern density at the central portion of the light adjustment pattern 800, intensity of the light radiating central portions of the sealant 500 may be lowered such that the overall intensity has the flat profile form along the entire width W of the sealant 500 and the sealant 500 may be uniformly cured.

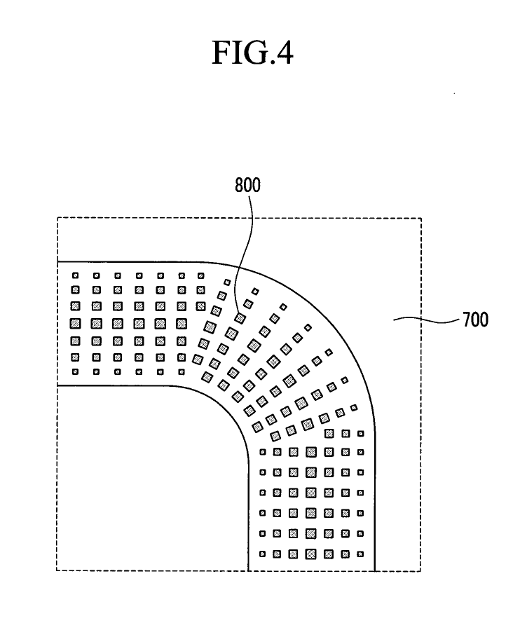

FIG. 4 illustrates an enlarged view of a portion B of FIG. 1.

As illustrated in FIG. 4, in the light adjustment pattern 800 corresponding to the portion B of FIG. 1, the pattern density may increase toward the inside area of the light adjustment pattern 800 corresponding to the inside portion of the sealant 500 in order to uniformly irradiate heat energy to an inside portion adjacent to the display unit 300 at a corner portion of the sealant 500 while changing heat energy, i.e., intensity, of laser light L (shown in FIG. 10) transmitted through the light adjustment pattern 800 from a Gaussian profile form to a flat profile form. Thus, pattern density may increase toward the inside area of the light adjustment pattern 800 corresponding to portion B of FIG. 1 at the corner portion of the sealant 500. Accordingly, due to the increased pattern density toward the inside area, intensity of the light radiating inside portions of the sealant 500 may be lowered such that the sealant 500 may be uniformly cured.

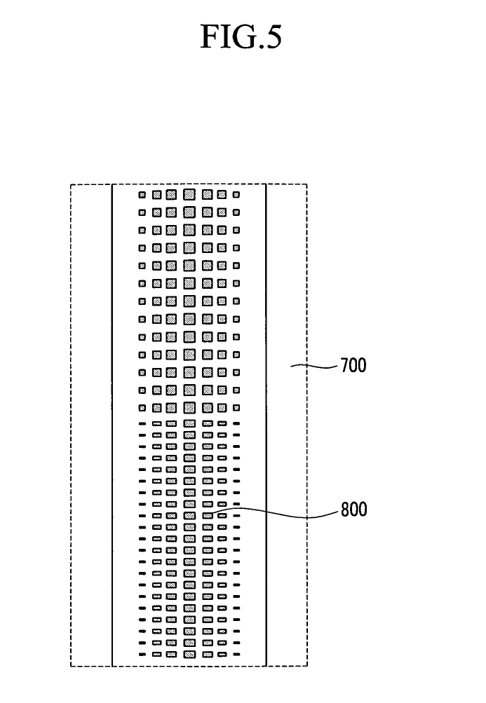

FIG. 5 illustrates an enlarged view of a portion C of FIG. 1.

As illustrated in FIG. 5, in the light adjustment pattern 800 corresponding to portion C of FIG. 1, a part of the sealant 500 may overlie the wire unit 200. When curing portions of the sealant 500 overlying the wire unit 200, the wire unit 200 may be damaged by high heat energy of laser light L radiated to the sealant 500. Accordingly, portions of the light adjustment pattern 800 corresponding to portions of the sealant 500 overlying the wire unit 200 may have a greater pattern density than other portions of the light adjustment pattern 800, i.e., portions not overlying the wire unit 200. Accordingly, heat energy, i.e., intensity, of laser light L transmitted through the light adjustment pattern 800 may be reduced. Thus, portions of the light adjustment pattern 800 corresponding to the portion C of FIG. 1, i.e., portions overlying the wire unit 200, may have a greater pattern density than other portions, i.e., portions not overlying the wire unit 200.

Thus, during curing of the sealant 500, as the light adjustment pattern 800 selectively changes the heat energy, i.e., intensity, of laser light L transmitted therethrough according to the position and shape of the sealant 500, heat energy of laser light L may be uniformly radiated to the sealant 500 through the light adjustment pattern 800.

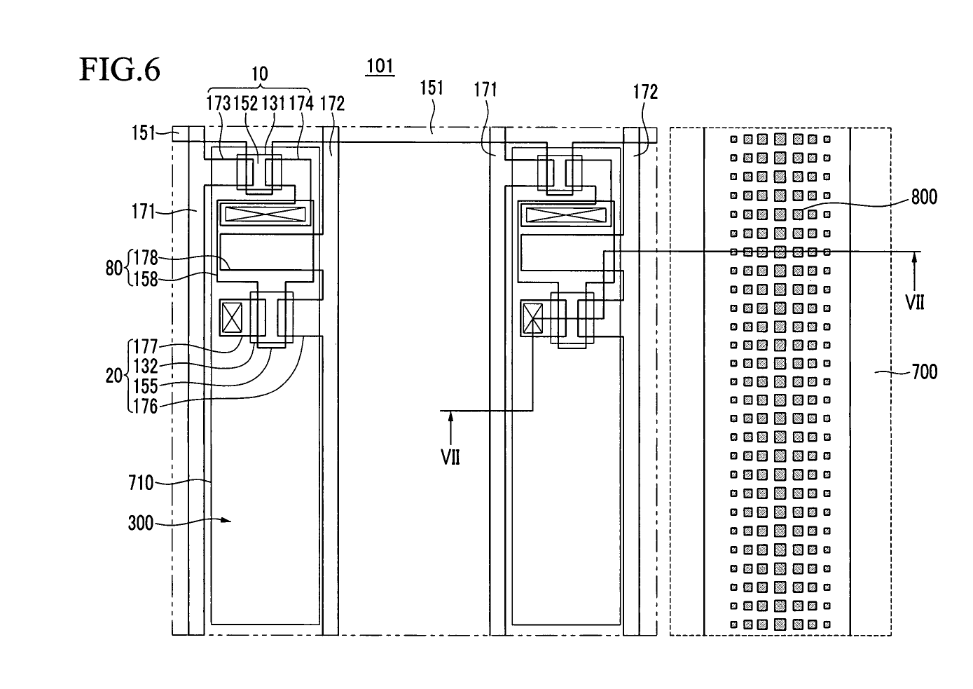

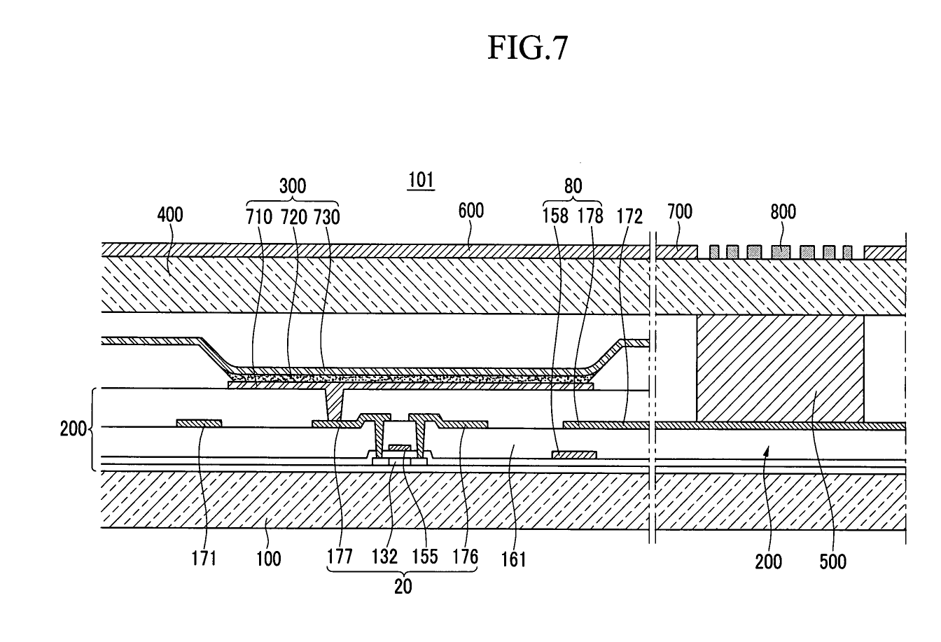

An inner structure of the display device 101 will be described hereinafter in detail with reference to FIGS. 6 and 7.

FIG. 6 illustrates a layout view of a structure of a pixel of the display device according to an embodiment. FIG. 7 illustrates a cross-sectional view of the pixel taken along line VII-VII of FIG. 6.

Hereinafter, a detailed structure of the wire unit 200 and the display unit 300 is illustrated in FIGS. 6 and 7, but the embodiments are not limited thereto. The wire unit 200 and the display unit 300 may be formed in various structures within a range that can be easily modified by a person of ordinary skill in the art. For example, in the accompanying drawings, as a display device, an active matrix (AM) type of OLED display of a 2Tr-1Cap structure having two thin film transistors (TFT) and one capacitor in one pixel is described, but the embodiments are not limited thereto. Therefore, in the display device, the quantity of the thin film transistor, the quantity of the capacitor, and the quantity of the wire are not limited. A pixel is a minimum unit that displays an image, and the display device displays an image through a plurality of pixels.

As illustrated in FIGS. 6 and 7, the display device 101 may include, e.g., a switching thin film transistor 10, a driving thin film transistor 20, a capacitor 80, and a display unit 300 that are, respectively, formed in each pixel. Here, a configuration including the switching thin film transistor 10, the driving thin film transistor 20, and the capacitor 80 is referred to as the wire unit 200. The wire unit 200 may further include a gate line 151 disposed in one direction of the first substrate 100, and a data line 171 and a common power source line 172 insulated from and intersecting the gate line 151. Here, a pixel is defined by the gate line 151, the data line 171, and the common power source line 172 as the boundary, but a pixel is not limited thereto.

The display unit 300 may include a first electrode 710, an organic emission layer 720 on the first electrode 710, and a second electrode 730 on the organic emission layer 720. The first electrode 710, the organic light emitting layer 720, and the second electrode 730 may form an OLED. Here, the first electrode 710 may be an anode, which is a hole injection electrode. The second electrode 730 may be a cathode, which is an electron injection electrode. However, the embodiments are not limited thereto; and the first electrode 710 may be a cathode and the second electrode 730 may be an anode according to a driving method of the display device 101. When holes and electrons are injected into the organic emission layer 720 from the first electrode 710 and the second electrode 730, respectively, and when excitons formed by coupling of holes and electrons injected into the organic emission layer 720 are dropped from an exited state to a ground state, the organic emission layer 720 may emit light.

Further, in the display device 101 according to an embodiment, the display unit 300 may emit light in a direction of the second substrate 400. That is, the display unit 300 may be a front surface light emitting type. Here, in order for the display unit 300 to emit light in a direction of the second substrate 400, the first electrode 710 may be made of a light reflecting conducting material and the second electrode 730 may be made of a light transmitting conducting material. However, the embodiments are not limited thereto; and the display unit 300 may emit light in a direction of the first substrate 100 or in directions of the first substrate 100 and the second substrate 400 according to a driving method of the display device 101.

The capacitor 80 may include a pair of capacitor plates 158 and 178 with an interlayer insulating layer 161 interposed therebetween. Here, the interlayer insulating layer 161 may be a dielectric material; and a capacitance of the capacitor 80 may be determined by charges that are stored in the capacitor 80 and a voltage between both capacitor plates 158 and 178.

The switching thin film transistor 10 may include a switching semiconductor layer 131, a switching gate electrode 152, a switching source electrode 173, and a switching drain electrode 174. The driving thin film transistor 20 may include a driving semiconductor layer 132, a driving gate electrode 155, a driving source electrode 176, and a driving drain electrode 177.

The switching thin film transistor 10 may be used as a switch that selects a pixel to emit light. The switching gate electrode 152 may be connected to the gate line 151. The switching source electrode 173 may be connected to the data line 171. The switching drain electrode 174 may be separated from the switching source electrode 173 and may be connected to one capacitor plate (158 in this case).

The driving thin film transistor 20 may apply a driving power source for allowing light emitting of the organic emission layer 720 of the display unit 300 within the selected pixel to the first electrode 710. The driving gate electrode 155 may be connected to the capacitor plate 158 that may be connected to the switching drain electrode 174. The driving source electrode 176 and the other capacitor plate 178 may each be connected to the common power source line 172. The driving drain electrode 177 may be connected to the first electrode 710 of the display unit 300 through a contact hole.

By such a structure, the switching thin film transistor 10 may operate by a gate voltage applied to the gate line 151 and may thus perform a function of transferring a data voltage applied to the data line 171 to the driving thin film transistor 20. A voltage corresponding to a difference between a common voltage applied from the common power source line 172 to the driving thin film transistor 20 and a data voltage transferred from the switching thin film transistor 10 may be stored in the capacitor 80. A current corresponding to a voltage stored in the capacitor 80 may flow to the display unit 300 through the driving thin film transistor 20, and thus the display unit 300 may emit light.

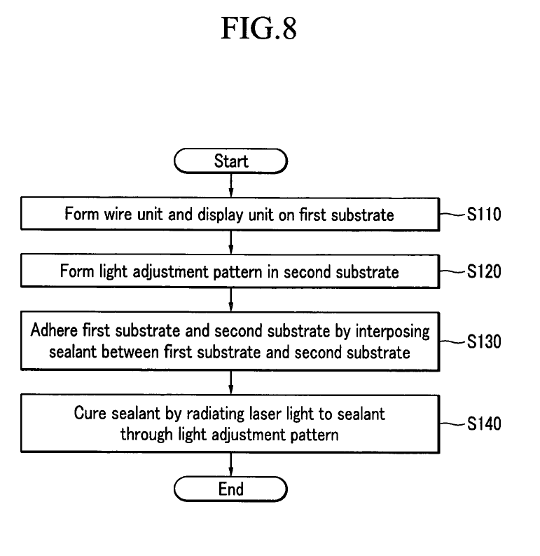

A method of manufacturing the display device 101 according to an embodiment will be described hereinafter with reference to FIGS. 8 to 12.

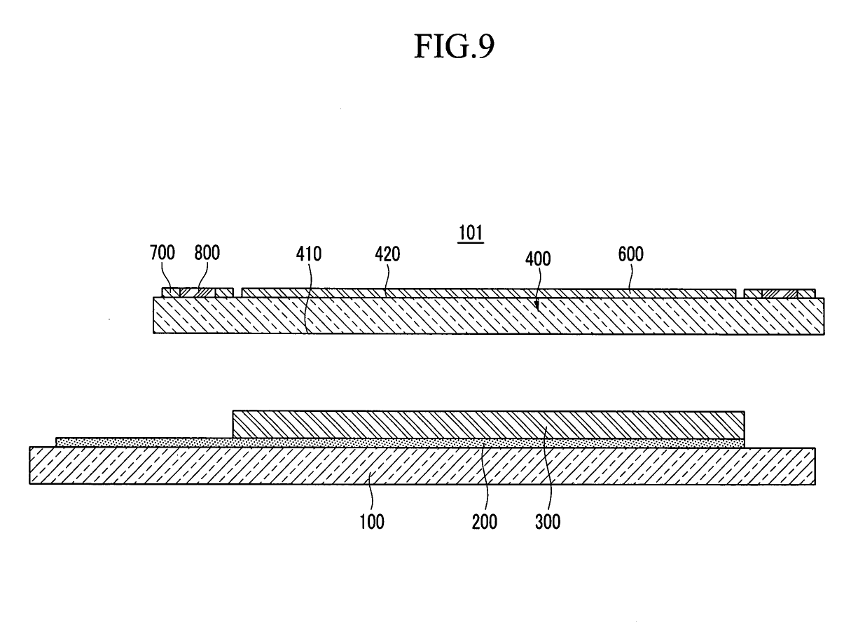

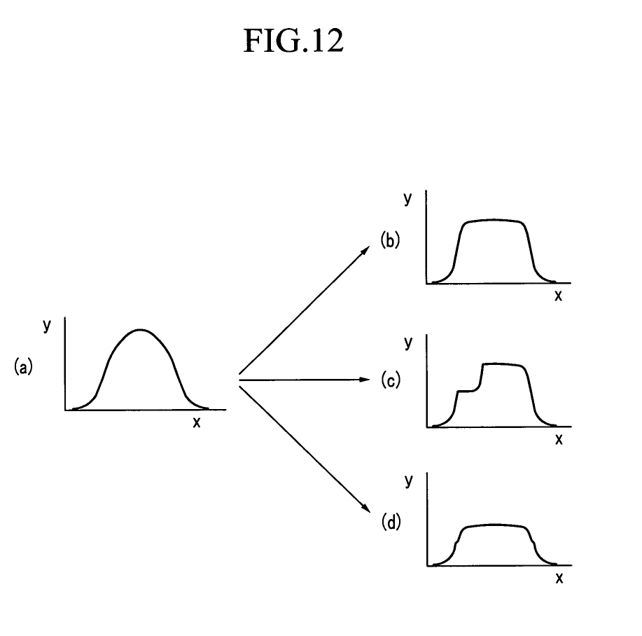

FIG. 8 illustrates a flowchart of a method of manufacturing a display device according to an embodiment. FIGS. 9 to 11 illustrate diagrams of stages in a method of manufacturing a display device of FIG. 8. FIG. 12 illustrates graphs of heat energy profiles of laser light used to cure sealant in the method of manufacturing a display device of FIG. 8.

As illustrated in FIGS. 8 and 9, the wire unit 200 and the display unit 300 may be formed on the first substrate 100 (S110).

Specifically, in a display area on the first substrate 100, the wire unit 200 and the display unit 300 may be formed using microelectromechanical systems (MEMS) technology, e.g., photolithography.

Next, the light adjustment pattern 800 may be formed on the second substrate 400 (S120).

Specifically, the light adjustment pattern 800 may be formed on the second surface 420 of the second substrate 400. When the first substrate wire 600 is formed on the second surface 420 of the second substrate 400, the light adjustment pattern 800 may be simultaneously formed. In an implementation, when the first substrate wire 600 and the light adjustment pattern 800 are formed, the light interception unit 700 may also be simultaneously formed. The light adjustment pattern 800, the first substrate wire 600, and the light interception unit 700 may be formed simultaneously, i.e., by a single process using MEMS technology, e.g., photolithography. In particular, the light adjustment pattern 800 and the light interception unit 700 may be formed from the same material as a metal wire included in the first substrate wire 600. In an implementation, the light adjustment pattern 800, the light interception unit 700; and the first substrate wire 600 may be formed in the same plane.

In an implementation, the light adjustment pattern 800 may be formed on the first surface 410 of the second substrate 400. In this case, when a second substrate wire 900 is formed on the first surface 410 of the second substrate 400, the light adjustment pattern 800 and the light interception unit 700 may be simultaneously formed on the first surface 410 of the second substrate 400. Thus, the light adjustment pattern 800, the second substrate wire 900, and the light interception unit 700 may be formed on the first surface 410 of the second substrate 400, i.e., on the same plane, simultaneously, i.e., by a single process.

Next, as illustrated in FIG. 10, by interposing the sealant 500 between the first substrate 100 and the second substrate 400, the first substrate 100 and the second substrate 400 may be adhered together (S130).

Specifically, the sealant 500 including, e.g., frit, etc., cured by laser light L may be interposed between the first substrate 100 and the second substrate 400. In this case, the sealant 500 may be interposed between the first substrate 100 and the second substrate 400 such that the sealant 500 may correspond to the light adjustment pattern 800 on the second substrate 400. In other words, the light adjustment pattern 800 may overlie the sealant 500. Then, the first substrate 100 and the second substrate 400 may be adhered such that the display unit 300 may be positioned between and encapsulated by the first substrate 100 and the second substrate 400 using the sealant 500.

Next, by radiating laser light L to the sealant 500 through the light adjustment pattern 800, the sealant 500 may be cured (S140).

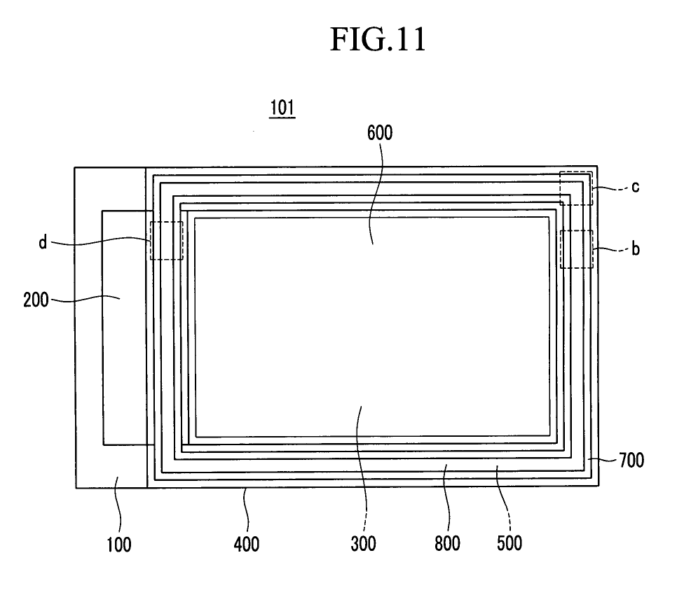

Specifically, by radiating laser light L from a laser device LA to the sealant 500 through the light adjustment pattern 800, the sealant 500 may be cured. In this case, a profile of heat energy of laser light L radiated to the sealant 500 through the light adjustment pattern 800 may change according to the shape and position of the sealant 500; and this will be described hereinafter in detail with reference to FIGS. 11 and 12.

As illustrated in FIGS. 11 and 12, laser light L first irradiated from the laser device LA may have first heat energy of a Gaussian profile form, e.g., may have a form as illustrated in FIG. 12(a). In FIG. 12, the x-axis represents a width of laser light L and the y-axis represents a heat energy amount of laser light L.

When laser light L from the laser device LA is radiated to the sealant 500 through the light adjustment pattern 800 extending along a circumference of the display unit 300 and corresponding to, i.e., overlying, the sealant 500, the profile of the heat energy may change. In particular, when laser light L passes through the light adjustment pattern 800 of a region b of FIG. 11, the laser light L may transform from first heat energy having a Gaussian profile form as illustrated in FIG. 12(a) to second heat energy having a flat profile form as illustrated in FIG. 12(b). Thus, heat energy may be uniformly irradiated to the entire sealant 500. Accordingly, the sealant 500 may be uniformly cured. In other words, the heat energy, i.e., intensity, of the laser light L may be uniform across the entire width W of the sealant 500.

In addition, when laser light L passes through a region c of FIG. 11, the laser light L may transform from a first heat energy having a Gaussian profile form as illustrated in FIG. 12(a) to third heat energy having a stepped flat profile form as illustrated in FIG. 12(c). In other words, the third heat energy may have an energy difference, i.e., a portion of the profile may have an energy equal to the second heat energy described above and a portion may have a heat energy lower than the second heat energy. The portion having the lower heat energy may correspond to an inside portion of the corner portion of the sealant 500. Accordingly, the corner portion of the sealant 500 may be uniformly cured.

Further, when laser light L passes through a region d of FIG. 11, the laser light L may transform from first heat energy having a Gaussian profile form as illustrated in FIG. 12(a) to fourth heat energy having a flat profile form, i.e., having less energy than the second heat energy illustrated in FIG. 12(d). The region d of FIG. 11 may be a region in which the sealant 500 overlies the wire unit 200. As the laser light L transforms to the fourth heat energy by passing through the light adjustment pattern 800, damage to the wire unit 200 may be suppressed, while heat energy is uniformly transferred to the entire sealant 500. Accordingly, while a portion of the sealant 500 that overlies the wire unit 200 is uniformly cured, the wire unit 200 may not be damaged by the laser light L.

As the light adjustment pattern 800 selectively transforms the heat energy, i.e., intensity, profile of laser light L radiated to the sealant 500 through the light adjustment pattern 800 according to the shape and position of the sealant 500, the entire sealant 500 may be uniformly cured by the laser light L. In addition, damage to the wire unit 200 that otherwise could be caused by the laser light L is suppressed.

As described above, in the display device 101 and the method of manufacturing the display device 101 according to the present embodiment, when the sealant 500 is cured, as the light adjustment pattern 800 selectively changes heat energy of laser light L that passes therethrough according to the position and shape of the sealant 500, heat energy of the laser light L may be uniformly radiated to the sealant 500 through the light adjustment pattern 800; and thus the entire sealant 500 may be uniformly cured.

Further, in the display device 101 and the method of manufacturing the display device 101 according to the present embodiment, as the light adjustment pattern 800 that substantially functions as a mask for laser light L is formed on the second substrate 400, it may not be necessary to use a separate mask for, e.g., adjusting the intensity of the laser light L. Accordingly, manufacturing time and manufacturing cost may be reduced.

Further, the display device 101 according to the present embodiment may not require an additional process to form the light adjustment pattern 800. Rather, the light adjustment pattern 800 may be formed simultaneously with forming the first substrate wire 600 on the second surface 420 of the second substrate 400. Thus, additional manufacturing time and manufacturing cost may be unnecessary.

In short, in the display device 101 and in the method of manufacturing the display device 101 according to the present embodiment, as the light adjustment pattern 800 that substantially performs a function as a mask for laser light L is formed on the second substrate 400, the heat energy profile of the laser light L that selectively passes through the light adjustment pattern 800 may change according to the shape and position of the sealant 500. Thus, curing of the sealant 500 between the first substrate 100 and the second substrate 400 may be uniformly performed, damage to the wire unit 200 by laser light L may be suppressed, and an additional mask for adjusting laser light L may be rendered unnecessary. Thus, manufacturing time and manufacturing costs may be reduced.

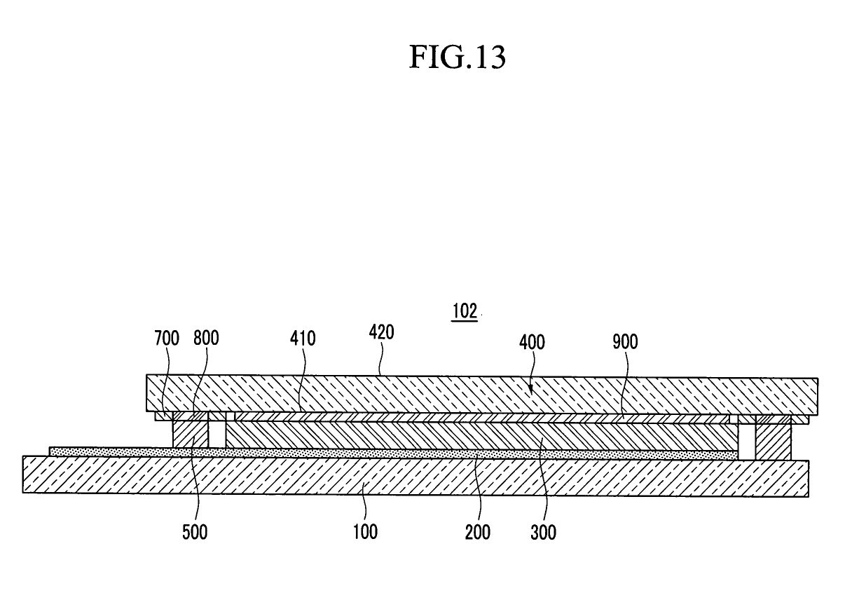

A display device 102 according to another embodiment will be described hereinafter with reference to FIG. 13.

FIG. 13 illustrates a cross-sectional view of a display device according to another embodiment.

As illustrated in FIG. 13, the display device 102 according to the present embodiment may include a second substrate wire 900.

The second substrate wire 900 may be disposed on the first surface 410 of the second substrate 400 facing the display unit 300. The second substrate wire 900 may correspond to a position of the display unit 300. The second substrate wire 900 may include at least one of, e.g., a metal wire, at least one thin film transistor, and a sensing material. The second substrate wire 900 may improve an electrical resistance value of the second electrode 730 by contacting the second electrode 730 of the display unit 300. The light interception unit 700 and the light adjustment pattern 800 corresponding to, i.e., overlying, the sealant 500 between the first substrate 100 and the second substrate 400 may be formed on the first surface 410 of the second substrate 400, i.e., in the same plane as that of the second substrate wire 900.

As described above, in the display device 102 according to the present embodiment, the light adjustment pattern 800 formed on the second substrate 400 may substantially function as a mask for, e.g., adjusting the intensity of, laser light L. A heat energy profile of laser light L that selectively passes through the light adjustment pattern 800 may change according to a shape and position of the sealant 500 so that curing of the sealant 500 may be uniformly performed, damage of the wire unit 200 by laser light L may be suppressed, and an additional mask for adjusting the laser light L may be rendered unnecessary. Thus manufacturing time and manufacturing cost may be reduced.

However, in a conventional OLED display, when using frit as a sealant, laser light may be used as a curing means of the sealant. Because the heat energy of the laser light may have a Gaussian profile, the sealant may not be uniformly cured.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A display device, comprising:
a first substrate;
a display unit on the first substrate, the display unit being for displaying an image;
a wire unit between the display unit and the first substrate, the wire unit being for transferring a signal to the display unit;
a second substrate opposite to the first substrate with the display unit interposed therebetween;
a sealant between the first substrate and the second substrate; and
a light adjustment pattern on the second substrate, the light adjustment pattern overlying the sealant to adjust an amount of light transmitted therethrough.

2. The display device as claimed in claim 1, wherein:
the sealant extends along a surface of the first substrate to enclose the display unit, and
the light adjustment pattern is disposed on the second substrate to overlie the sealant.

3. The display device as claimed in claim 2, wherein the light adjustment pattern has a pattern density, the pattern density increasing toward a central area corresponding to a central portion of the sealant.

4. The display device as claimed in claim 2, wherein:
the sealant includes a corner portion,
the light adjustment pattern includes a portion overlying the corner portion of the sealant and having a pattern density, and
in such portion of the light adjustment pattern which overlies the corner portion of the sealant, the pattern density increases toward an inside area corresponding to an inside portion of the sealant adjacent to the display unit.

5. The display device as claimed in claim 1, wherein:
a portion of the wire unit is disposed between the sealant and the first substrate,
the light adjustment pattern includes a portion overlying the portion of the wire unit between the sealant and the first substrate, and the light adjustment pattern having a pattern density, and
the pattern density of the light adjustment pattern portion overlying the wire unit is greater than a pattern density of portions of the light adjustment pattern not overlying the wire unit.

6. The display device as claimed in claim 1, wherein the wire unit includes at least one thin film transistor, the thin film transistor having a gate electrode, a source electrode, a drain electrode, and an active layer.

7. The display device as claimed in claim 6, wherein the display unit includes:
a first electrode electrically connected to the drain electrode;
an organic emission layer on the first electrode; and
a second electrode on the organic light emitting layer.

8. The display device as claimed in claim 1, further comprising a light interception unit on the second substrate, the light interception unit surrounding the light adjustment pattern and defining a width of the light adjustment pattern.

9. The display device as claimed in claim 1, wherein the sealant is frit, the frit being curable by laser light.

10. The display device as claimed in claim 1, further comprising a first substrate wire on a second surface of the second substrate and opposite to a first surface of the second substrate, the first surface of the second substrate facing the display unit,
wherein the light adjustment pattern is disposed on the second surface in a same plane as the first substrate wire.

11. The display device as claimed in claim 1, further comprising a second substrate wire on a first surface of the second substrate, the first surface facing the display unit,
wherein the light adjustment pattern is disposed on the first surface in a same plane as the second substrate wire.

12. A method of manufacturing a display device, the method comprising:
forming a wire unit and a display unit on a first substrate such that the display unit receives a signal from the wire unit;
forming a light adjustment pattern on a second substrate such that the light adjustment pattern adjusts an amount of light transmitted therethrough;
adhering together the first substrate and the second substrate with the display unit interposed therebetween by interposing a sealant between the first substrate and the second substrate such that the sealant encloses at least a part of the display unit and such that the light adjustment pattern overlies the sealant; and
curing the sealant by irradiating laser light to the sealant through the light adjustment pattern.

13. The method as claimed in claim 12, wherein irradiating laser light to the sealant through the light adjustment pattern changes an intensity of the laser light from a Gaussian profile form to a flat profile form having a first heat energy.

14. The method as claimed in claim 12, wherein irradiating laser light to a corner portion of the sealant through the light adjustment pattern changes an intensity of the laser light from a Gaussian profile form to a stepped flat profile form having a first heat energy and a second heat energy lower than the first heat energy.

15. The method as claimed in claim 12, wherein irradiating laser light to a portion of the sealant overlying a portion of the wire unit through the light adjustment pattern changes an intensity of the laser light from a Gaussian profile form to a flat profile form having a third heat energy less than the first heat energy.

16. The method as claimed in claim 12, further comprising forming a first substrate wire on a second surface of the second substrate opposite to a first surface of the second substrate facing the display unit,
wherein the light adjustment pattern is formed simultaneously with and in a same plane as the first substrate wire.

17. The method as claimed in claim 12, further comprising forming a second substrate wire on a first surface of the second substrate to face the display unit,
wherein the light adjustment pattern is formed simultaneously with and in a same plane as the second substrate wire.

18. The method as claimed in claim 12, further comprising forming a light interception unit at sides of the light adjustment pattern such that the light interception unit defines a width of the light interception pattern.
